(19) United States
(12) Patent Application Publication
(10) Pub. No.: US 2019/0026752 A1
(43) Pub. Date: Jan. 24, 2019

(54) SYSTEM FOR PROVIDING REAL PROPERTY INFORMATION ONLINE AND SYSTEM FOR PROVIDING SAFE TRANSACTION SERVICE USING BIGDATA-BASED GRADE CLASSIFICATION AND MARKET VALUE PREDICTION

(71) Applicant: Dong Min KIM, Seogwipo-si (KR)

(72) Inventor: Dong Min KIM, Seogwipo-si (KR)

(21) Appl. No.: 16/039,364

(22) Filed: Jul. 19, 2018

(30) Foreign Application Priority Data
Jul. 20, 2017 (KR) 10-2017-0091901
May 21, 2018 (KR) 10-2018-0057852

(51) Int. Cl. G06Q 30/00; G06Q 50/16

(52) U.S. Cl. CPC G06Q 30/0185; G06Q 50/167

(57) ABSTRACT

According to an embodiment, a system for providing real property information comprises an agent terminal configured to transmit real property information and transaction information to an transaction server, a real property verification terminal configured to receive the real property information and the transaction information from the transaction server, receive fake listing verification information about a target property, and transmit the fake listing verification information to the transaction server, the transaction server configured to receive the real property information and the transaction information from the agent terminal, transmit the real property information and the transaction information to the real property verification terminal, receive the fake listing verification information from the real property verification terminal, generate a real property transaction screen displaying real property information, transaction information, and fake listing verification information per target property, and provide the real property transaction screen to a customer terminal, and a wired/wireless communication network.

### CROSS-REFERENCE TO RELATED APPLICATIONS

This patent application claims priority under 35 U.S.C. § 119 to Korean Patent Applications Nos. 10-2017-0091901 and 10-2018-0057852, respectively filed on Jul. 20, 2017 and May 21, 2018, in the Korean Intellectual Property Office, the disclosures of which are incorporated by reference herein in their entireties.

### TECHNICAL FIELD

Embodiments of the disclosure relate to systems for providing information online, and specifically, to systems for providing real property information online and providing a safe transaction service using bigdata-based grade classification and market value prediction.

### DISCUSSION OF RELATED ART

Real property, real estate, realty, or immovable property is land which is the property of some person and all structures (also called improvements or fixtures) integrated with or affixed to the land, including crops, buildings, machinery, wells, dams, ponds, mines, canals, and roads, among other things. Recently, as online real property transactions gain popularity, real property brokerage flourishes. However, many problems ensue accordingly. Among others, the fake listing issue is serious. Real property agents or realtors oftentimes list up homes, offices, or various types of real properties on the web or portals although they are not really subject to sale or rent to lure potential clients, thus causing significant confusion to transaction parties and the list-up information unreliable.

### SUMMARY

According to an embodiment, a system for providing real property information may comprise an agent terminal configured to receive real property information including information about an owner and a status of a target property and transaction information including an address, a transaction type, and a transaction price for the target property and to transmit the real property information and the transaction information to an transaction server to register the real property information and the transaction information in the transaction server, a real property verification terminal configured to receive the real property information and the transaction information from the transaction server, receive fake listing verification information about the target property, and transmit the fake listing verification information to the transaction server, the transaction server configured to receive the real property information and the transaction information about the target property from the agent terminal, transmit the real property information and the transaction information to the real property verification terminal, receive the fake listing verification information from the real property verification terminal, generate a screen for real property transaction (the screen is referred to herein as a “real property transaction screen”), which displays real property information, transaction information, and fake listing verification information per target property, and provide the real property transaction screen to a customer terminal, and a wired/wireless communication network configured to provide wired communication or wireless communication among the agent terminal, the real property verification terminal, the customer terminal, and the transaction server.

The fake listing verification information includes at least one or more of real property verification information verified as to whether the address of the target property is a property address provided from the agent terminal, information shown on the transcript of the register for the target property (hereinafter, simply referred to as “registration information”) including the address of the target property, debt information shown on the register transcript for the target property and including information about whether the target property is mortgaged or is auctioned, or information about whether other security interest or rights are attached to the target property, and residual value information about the target property.

The transaction server includes a server communication unit configured to communicate with each of the agent terminal and the real property verification terminal to receive the real property information and the transaction information about the target property from the agent terminal and receive the fake listing verification information from the real property verification terminal, a database configured to store and register, per target property, the real property information, the transaction information, and the fake listing verification information about the target property, a real property transaction screen generator configured to generate the real property transaction screen per target property, and a real property transaction screen provider configured to transmit the real property transaction screen to the customer terminal.

The real property transaction screen generator is configured to, when two or more target properties with the same address are registered by different agent terminals, prevent the target properties from being shown on the real property transaction screen.

The transaction server includes a debt grade determiner configured to determine a debt grade obtained by applying a degree of assets of the owner of the target property to the debt information. The real property transaction screen generator is configured to display, per target property, the debt grade, along with the real property information, the transaction information, and the fake listing verification information.

The debt grade determiner is configured to generate a relative debt grade obtained by applying a credit grade, as a weight, of the owner of the target property to the debt grade. The real property transaction screen generator is configured to display, per target property, the relative debt grade, along with the real property information, the transaction information, and the fake listing verification information.

The transaction server includes a residual value grade determiner configured to determine a residual value grade obtained by applying a degree of assets of the owner of the target property to the residual value information. The real property transaction screen generator is configured to display, per target property, the residual value grade, along with the real property information, the transaction information, and the fake listing verification information.

The residual value grade determiner is configured to generate a relative residual value grade obtained by applying a credit grade, as a weight, of the owner of the target property to the residual value grade. The real property transaction screen generator is configured to display, per target property, the relative residual value grade, along with the real property information, the transaction information, and the fake listing verification information.

The real property transaction screen provider is configured to limit target properties for which to provide the real property information, the transaction information, the fake listing verification information, and the residual value grades to real properties with the debt grade requested by the customer terminal and to limit target properties for which to provide the real property information, the transaction information, the fake listing verification information, and the residual value grades to real properties with the residual value grade requested by the customer terminal.

According to an embodiment, a system for providing a safe transaction service using bigdata-based grade classification and market value prediction may comprise a landlord terminal configured to register information about a real property for rent, search for information, including a market value, about ambient real properties with the same or similar conditions to the registered real property, when the registered real property is looked up, output statistically processed data for the registered real property including a hit count for the registered real property and information about people who looked up the real property, except for unique identification information about the people, and output information about a person that reserved for the registered real property so that a transaction status for the real property can be checked in real-time, a tenant terminal configured to search for the real property by entering at least one condition, unless the real property is searched for in real-time, apply for a notification that is to be sent when a real property meeting the condition is registered or listed up, and output a result of verifying whether the registered real property is a fake, and a safe transaction service providing server configured to output fake listing data regarding the real property for rent registered from the landlord terminal upon uploading the real property, transmit data about the tenant terminal, except for unique identification information about the tenant terminal, and rent payment status data to the landlord terminal when the tenant terminal looks up the real property for rent, assign user management grades to a tenant and a landlord based on information about the tenant and information about the landlord, determine whether the tenant and the landlord need to be monitored or managed, and serve bigdata-based real property statistical analysis data.

The safe transaction service providing server is configured to gather, in a form of bigdata, real property data including a location, a classification, and a price of the real property, internal data including a lot number and a house number, additional data including a register transcript, debt information, and residual value information, and open data including local statistics and index data. The debt information includes information about whether the real property registered is under mortgage or foreclosure, and a maximum claim amount shown on the register transcript. The residual value is generated with the landlord's credit grade reflected as a weight.

The safe transaction service providing server is configured to, in a parallel and distributive manner, store gathered raw data, which is bigdata, refine unstructed data, structed data, and semi-structed data contained in the raw data stored, perform pre-processing including classification with metadata, perform analysis, including data mining, on the pre-processed data, and visualize and output the analyzed data.

The safe transaction service providing server is configured to separately store market values depending on lot numbers and house numbers in the form of history logs and use at least one economical index that may influence the market values to provide a market value prediction according to the lot number and house number.

Regarding the user management grade, the safe transaction service providing server is configured to designate a management grade to a landlord who, despite the presence of a valid rent contact with a tenant, proceeds with another rent contract with a third party or for whom a brokerage accident history is discovered or designate a monitoring grade to a tenant who delays rent payment a preset number or more and for whom a preset condition is met and thus a complaint is made from the landlord.

The system for providing a safe transaction service using bigdata-based grade classification and market value prediction may further comprise a seller terminal and a buyer terminal. The safe transaction service providing server is configured to designate a special management grade to a seller with a seller terminal who withdraws his real property from the list at a preset frequency or cycles after negotiating a sale contract with a buyer or for whom a brokerage accident occurs and designate a special management grade to a buyer who requests to lower the price after negotiating a sale contract with a seller or for whom a brokerage accident occurs.

The system for providing a safe transaction service using bigdata-based grade classification and market value prediction may further comprise an agent terminal configured to provide the registered real property from the landlord to the safe transaction service providing server. When real properties with the same address as the registered real property are listed up by different agent terminals, the safe transaction service providing server is configured to abstain from listing the real property up on a webpage, which the safe transaction service providing server provides, or deactivate the real property.

The safe transaction service providing server is configured to generate a recommendation list based on the tenant's preference and the similarity of the real property for rent which meets at least one condition with a list of real properties for rent output under at least one condition and transmit the recommendation list to the tenant terminal and, when the real property in the real property list is included in a multi-unit building, transmit tenant information about any one of the upper, lower, left, and right apartment houses of the target apartment house, with the unique identification information excluded, to the tenant terminal.

The safe transaction service providing server is configured to, when the tenant enters at least one condition and searches for real properties for rent, extract and search for a keyword corresponding to the at least one condition and a set of similar or associated words with the keyword from the database previously storing the keyword set, and when the real property is searched for with an associated and similar word which is not the same as the keyword, allow the similarity between the keyword corresponding to the at least one condition and the searched-for real property on the real property list which is output from the tenant terminal.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a view illustrating a configuration of an online real property information providing system to prevent fake listings according to an embodiment;

FIG. 2 is a view illustrating a process for providing real property information online to prevent fake listings according to an embodiment;

FIG. 3 is a block diagram illustrating a configuration of a real property transaction server according to an embodiment;

FIG. 4 is a view illustrating a real property transaction screen according to an embodiment;

FIG. 5 is a view illustrating the weight of debt as per the degree of assets owned, according to an embodiment;

FIG. 6 is a view illustrating a real property transaction screen displaying debt grades and residual value grades according to an embodiment;

FIG. 7 is a view illustrating a safe transaction service providing system for a real property using bigdata-based grade classification and market value prediction according to an embodiment;

FIG. 8 is a block diagram illustrating a configuration of a system for providing a real property transaction service based on bigdata by a safe transaction service providing server included in the system of FIG. 7;

FIG. 9 is a view illustrating an exemplary implementation of a service of recommending a real property for sale while reflecting input conditions by a safe transaction service providing server included in the system of FIG. 7;

FIG. 10 is a view illustrating functions that a safe transaction service providing method for a real property using bigdata-based grade classification and market value prediction provides to an real property agent, a tenant, and a landlord, according to an embodiment; and

FIG. 11 is a view illustrating an example of verifying a fake listing by a safe transaction service providing method for a real property using bigdata-based grade classification and market value prediction according to an embodiment.

### DETAILED DESCRIPTION

Hereinafter, exemplary embodiments of the inventive concept will be described in detail with reference to the accompanying drawings. The inventive concept, however, may be modified in various different ways, and should not be construed as limited to the embodiments set forth herein. Like reference denotations may be used to refer to the same or similar elements throughout the specification and the drawings. However, the present invention may be implemented in other various forms and is not limited to the embodiments set forth herein. For clarity of the disclosure, irrelevant parts are removed from the drawings, and similar reference denotations are used to refer to similar elements throughout the specification.

In embodiments of the present invention, when an element is “connected” with another element, the element may be “directly connected” with the other element, or the element may be “electrically connected” with the other element via an intervening element. When an element “comprises” or “includes” another element, the element may further include, but rather than excluding, the other element, and the terms “comprise” and “include” should be appreciated as not excluding the possibility of presence or adding one or more features, numbers, steps, operations, elements, parts, or combinations thereof.

When the measurement of an element is modified by the term “about” or “substantially,” if a production or material tolerance is provided for the element, the term “about” or “substantially” is used to indicate that the element has the same or a close value to the measurement and is used for a better understanding of the present invention or for preventing any unscrupulous infringement of the disclosure where the exact or absolute numbers are mentioned. As used herein, “step of” A or “step A-ing” does not necessarily mean that the step is one for A.

As used herein, the term “part” may mean a unit or device implemented in hardware, software, or a combination thereof. One unit may be implemented with two or more hardware devices or components, or two or more units may be implemented in a single hardware device or component.

As used herein, some of the operations or functions described to be performed by a terminal or device may be, instead of the terminal or device, performed by a server connected with the terminal or device. Likewise, some of the operations or functions described to be performed by a server may be performed by a terminal or device connected with the server, instead of the server.

As used herein, some of the operations or functions described to be mapped or matched with a terminal may be interpreted as mapping or matching the unique number of the terminal, which is identification information about the terminal, or personal identification information.

Hereinafter, embodiments of the disclosure are described in detail with reference to the accompanying drawings.

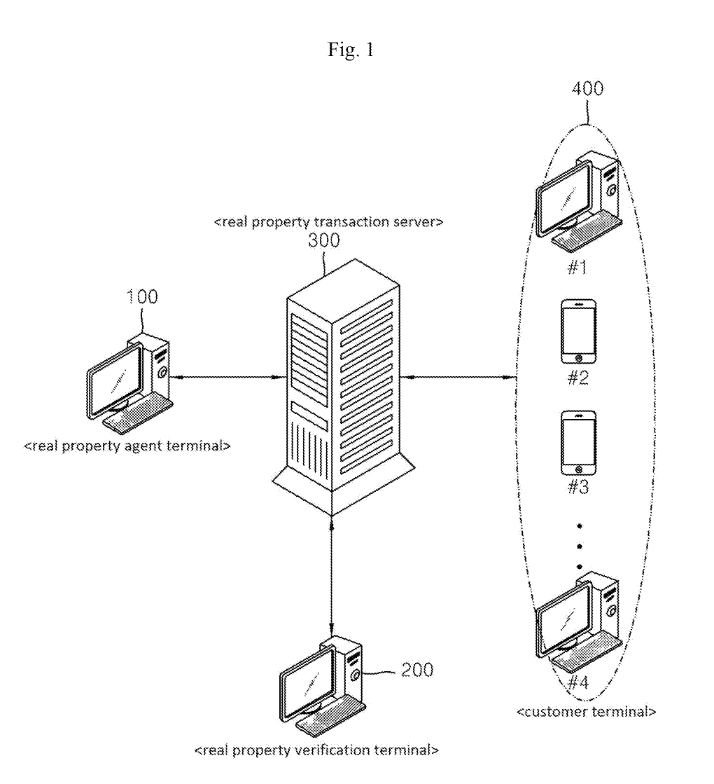

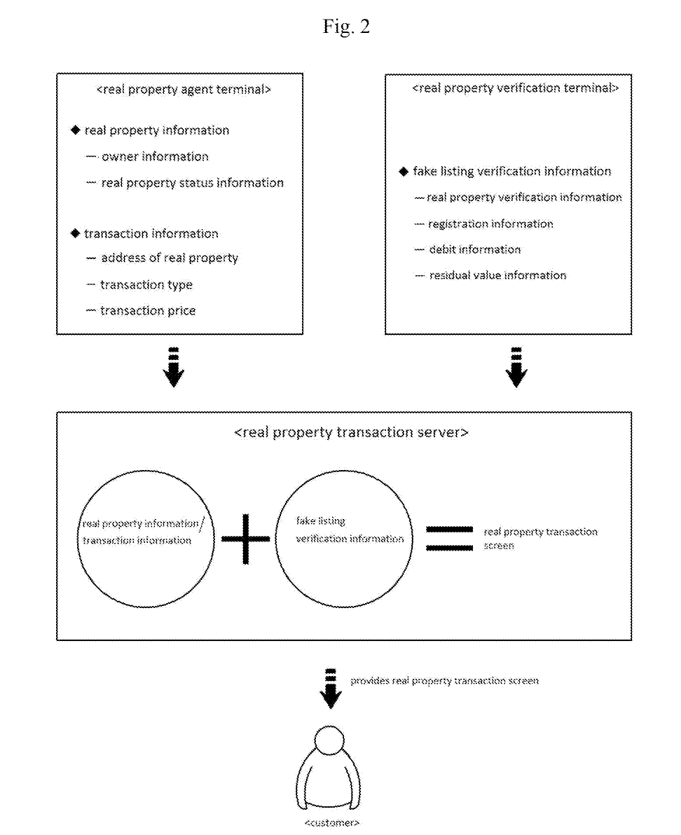

FIG. 1 is a view illustrating a configuration of an online real property information providing system to prevent fake listings according to an embodiment. FIG. 2 is a view illustrating a process for providing real property information online to prevent fake listings according to an embodiment.

According to the present invention, a real property title report/details and an expert opinion are provided to prevent fake real property listings. Accordingly, whatever type of real property transaction (e.g., sale or rent) is made, the exact addresses of the properties are listed. This may prevent fake listings and enables safer brokerage and accurate analysis of the properties.

According to the present invention, the online real property information providing system to prevent fake listings present the following features.
enables exact address entry for target real properties (e.g., xx-apartment building x-dong x-h, xx, Yeoksam-dong, Gangnam-gu)
provides a transcript of the register at the time of the registration of the property at the address
provides mortgage and debt information shown on the transcript of the register regarding the property
provides an expert's analysis and opinion on the value of the property for sale (e.g., an expert's opinion as to whether a property which is now on rent is still valuable even after the deposit is deducted)

Now described in detail is a real property information providing system to prevent fake lists according to the present invention.

Referring to FIG. 1, the real property information providing system may include a wired/wireless communication network (not shown), a real property agent terminal 100, a real property verification terminal 200, a customer terminal 400, and a real property transaction server 300.

The wired/wireless communication network (not shown) provides wired or wireless communication among the real property agent terminal 100, the real property verification terminal 200, the customer terminal 400, and the real property transaction server 300. Where the wired/wireless communication network is implemented as a wireless communication network, data communication may be performed via a wireless mobile communication network including a base station (or base transceiver station (BTS)), a mobile switching center (MSC), and a home location register (HLR). Where the wired/wireless communication network is implemented as a wired communication network, data communication may be performed as per internet protocols, such as transmission control protocol/internet protocol (TCP/IP).

The real property agent terminal 100 is a real property agent's terminal. Although in the drawings the real property agent terminal 100 is shown to be a desktop PC, the real property agent terminal 100 may be other various communication terminals, such as a laptop computer, smartphone, or tablet PC.

The real property agent terminal 100 receives real property information about a target property for transaction (hereinafter, referred to as a ‘target property’ or ‘target real property’) and transaction information from the agent and transmits the information to the real property transaction server 300 that then registers the information. The real property information includes information about the owner and state of the target property. The owner information includes, e.g., personal information about the owner, and the property state information includes the size, traffic environment, or ambient information about the property. The transaction information includes the address of the property, and the transaction type and price. The transaction type means what kind of transaction is performed, e.g., sale or rent.

The real property verification terminal 200 is a terminal that a real property expert has and uses to verify whether the listed property is a fake. Although in the drawings the real property verification terminal 200 is shown to be a desktop PC, the real property verification terminal 200 may be other various communication terminals, such as a laptop computer, smartphone, or tablet PC. The real property verification terminal 200 receives the property information and transaction information about the target property from the real property transaction server 300 and receives fake listing verification information about the target property and transmits the fake listing verification information to the real property transaction server 300.

The fake listing verification information includes at least one or more of real property verification information verified as to whether the address of the target property is the property address provided from the real property agent terminal 100, registration information about the address of the target property, debt information setting forth, on the register transcript for the target property, debt information including information about whether the target property has been mortgaged or is auctioned, and residual value of the target property. The real property expert may grasp and analyze the real property verification information, registration information, debt information, and residual value information about each target property registered and enters the results of the analysis to the real property verification terminal 200 to be provided to the target property.

The real property verification information is information resulting from verifying whether the target property listed by the real property agent is really at the address and whether the state information, e.g., the size of the property, is correct. The registration information includes, e.g., a copy of the register for the target property listed by the real property agent. The debt information includes, e.g., information about mortgage or auction related to the target property listed by the real property agent. The residual value information includes, e.g., the expert's opinion and analysis on the residual value of the target property listed by the real property agent, such as whether the property—when the property is rented—is valuable enough to cover the deposit or whether there remains a surplus fund from the rented property even after the deposit is deducted from the current value of the property.

The customer terminal 400 is the terminal of a customer, e.g., a potential purchaser or tenant who intends to purchase or rent the property. Although in the drawings the customer terminal 400 is shown to be a desktop PC, the customer terminal 400 may be one of other various types of communication terminals, such as a smartphone, tablet PC, or laptop computer.

The customer terminal 400 receives fake listing verification information and receives, from the real property transaction server 300, and displays a real property transaction screen containing real property information, transaction information, and fake listing verification information per target property. The customer may easily grasp whether the property he attempts to transact really exists, the register transcript, the debt status, and the residual value through the real property transaction screen.

The real property transaction server 300 may have substantially the same configuration as a typical web server in terms of hardware and may be implemented in various programming languages, such as C, C++, Java, Visual Basic, or Visual C in terms of software while including programming modules that have various functions. The real property transaction server 300 may also be implemented by combining various web server programs which are provided depending on operating systems (OSs), such as Dos, Window, Linus, Unix, or Macintosh, with a common hardware device for servers.

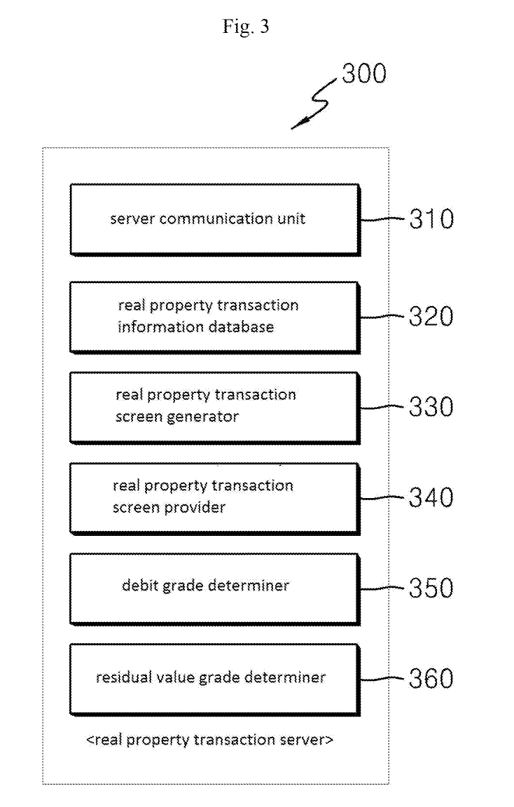

The real property transaction server 300 receives the real property information and transaction information about the target property from the real property agent terminal 100 and transmits the information to the real property verification terminal 200. The real property transaction server 300 receives the fake listing verification information from the real property verification terminal 200, generates the real property transaction screen containing the real property information, transaction information, and fake listing verification information per target property, and provides the real property transaction screen to the customer terminal 400. For example, as shown in FIG. 2, the real property transaction server 300 receives the real property information and transaction information about the target property from the real property agent terminal 100, receives the fake listing verification information from the real property verification terminal 200, displays the received real property information, transaction information, and fake listing verification information on the real property transaction screen to be provided to the customer terminal 400. The real property transaction server 300 is described below in further detail with reference to FIGS. 3 to 6.

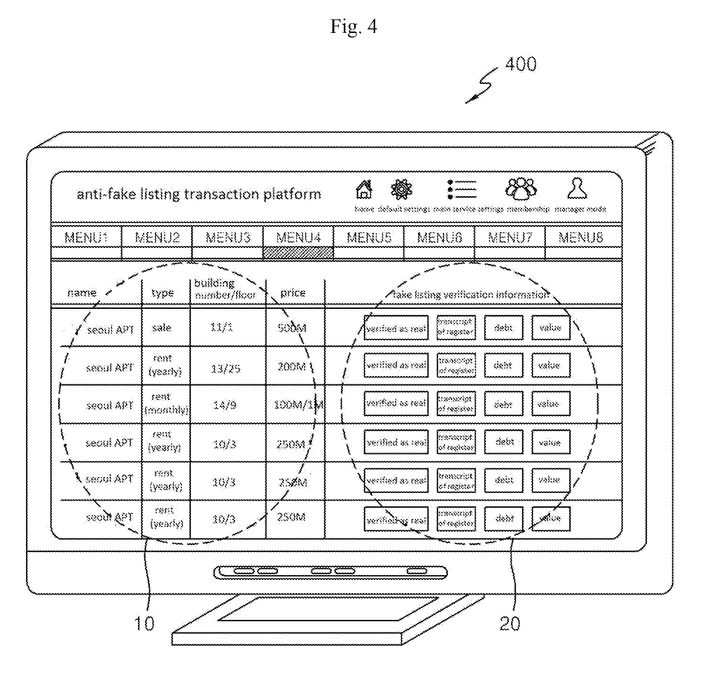

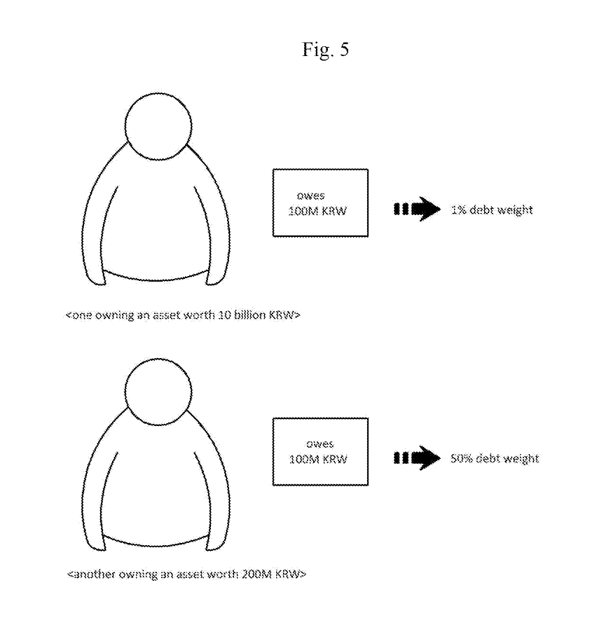

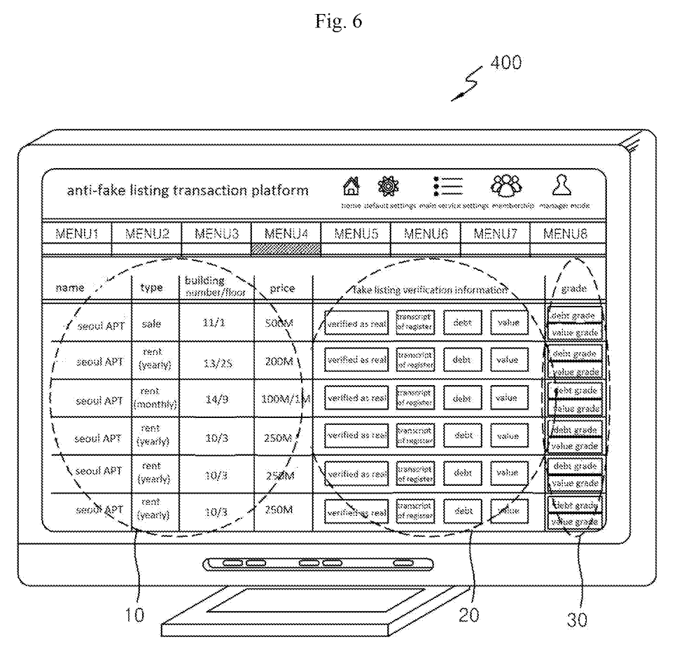

FIG. 3 is a block diagram illustrating a configuration of a real property transaction server according to an embodiment. FIG. 4 is a view illustrating a real property transaction screen according to an embodiment. FIG. 5 is a view illustrating the weight of debt as per the degree of assets owned, according to an embodiment. FIG. 6 is a view illustrating a real property transaction screen displaying debt grades and residual value grades according to an embodiment.

Referring to FIG. 3, the real property transaction server 300 may include a server communication unit 310, a real property transaction information database 320, a real property transaction screen generator 330, and a real property transaction screen provider 340. The real property transaction server 300 may further include a debt grade determiner 350 and a residual value grade determiner 360.

The server communication unit 310 supports the protocols for the hardware or software for communicating with the real property agent terminal 100 and the real property verification terminal 200. The server communication unit 310 may perform data communication as per internet protocols, such as TCP/IP. The server communication unit 310 receives the real property information and the transaction information about the target property from the real property agent terminal 100 and transmits the information to the real property verification terminal 200 and receives the fake listing verification information from the real property verification terminal 200. The server communication unit 310 transmits the real property transaction screen to the customer terminal 400.

The real property transaction information database 320 is a database (DB) to store and register the real property information, transaction information, and fake listing verification information per target property. The database may be provided inside the device, as a module capable of inputting or outputting information, such as a hard disk drive (HDD), a solid state drive (SSD), a flash memory, a compact flash (CF) card, a secure digital (SD) card, a smart media (SM) card, a multi-media card (MMC), or a memory stick™, or the database may be provided in a separate device.

The real property transaction screen generator 330 generates a real property transaction screen displaying the real property information, transaction information, and fake listing verification information per target property. The real property transaction screen may be provided in the form of a real property webpage or real property application (app). For example, where the customer terminal 400 is a desktop PC, the real property transaction screen may be provided in the form of a real property webpage, and where the customer terminal 400 is a smartphone, the real property transaction screen may be provided in the form of a screen of a real property app. Where two or more listings are made for the same target property by different real property agent terminals 100, the real property transaction screen generator 330 prevents the target property from being displayed on the real property transaction screen. This is why the overlapping listings for the same target property are highly likely to be a fake and it is thus preferable to prevent the target property from being exposed via the real property transaction screen.

The real property transaction screen provider 340 transmits the generated real property transaction screen to the customer terminal 400. Thus, the real property transaction screen is displayed on the customer terminal 400 as shown in FIG. 4. The real property transaction screen may include a real property transaction information display section 10 to display real property information and transaction information and a fake listing verification information display section 20 to display fake listing verification information.

The fake listing verification information may include debt information. Regarding the debt information, the feeling about the debt may differ depending on the degree of assets of the owner of the real property. For example, the weight of debt may be felt significantly small by a person who owns about 10 billion Korean won (KRW) and owes one hundred million KRW as compared with another who has about two hundred million KRW and owes one hundred million KRW. Thus, there is a need for providing customers with debt grades given the degree of assets of the property owners.

To that end, the debt grade determiner 350 determines the debt grade that is obtained by applying the degree of assets of the target property owner to the debt information. For example, when the weight of debt is within 10%, the debt grade is determined to be good, when the weight of debt ranges from 10% to 40%, the debt grade is determined to be normal, and when the weight of debt exceeds 40%, the debt grade is determined to be bad.

The real property transaction screen generator 330 displays the per-target property debt grades, along with the real property information, transaction information, and fake listing verification information, in the debt grade display section 30, as shown in FIG. 6. Thus, customers may easily grasp the per-real property debt grades and hence the soundness of the property.

The debt grade determiner 350 may generate a relative debt grade obtained by applying the credit grade, as a weight, of the owner of the target property to the debt grade. For example, in determining the debt grade, when the credit grade of the owner is lower than a reference value, the owner's relative debt grade is determined to be one grade down, and when the credit grade of the owner is higher than the reference value, the owner's relative debt grade is determined to be one grade up. Since the debt risk may be varied in the future depending on the credit grade of the owner, the owner's credit grade is considered along with his debt grade.

The real property transaction screen generator 330 may display the real property information, transaction information, fake listing verification information, and relative debt grade per target property.

The fake listing verification information may include residual value information. Regarding the residual value information, the feeling about the residual value may differ depending on the degree of assets of the owner of the real property. For example, where one owning ten billion KRW and another owning 200 million KRW rent out their houses each of which is estimated 100 million KRW, the house of the other would have a higher chance of foreclosure. Thus, there is a need for providing customers with residual value grades given the degree of assets of the property owners.

To that end, the residual value grade determiner 360 determines the residual value grade that is obtained by applying the degree of assets of the target property owner to the residual value information about the target property. Regarding the degree of assets of the target property owner, information about the owner's assets may be obtained by looking up real transaction prices with the disclosure of the owner's information previously consented or may be received directly from the owner.

The real property transaction screen generator 330 displays the per-target property residual value grades, along with the real property information, transaction information, and fake listing verification information, in the debt grade display section 30, as shown in FIG. 6.

The residual value grade determiner 360 may generate a relative residual value grade obtained by applying the credit grade, as a weight, of the owner of the target property to the residual value grade. For example, in determining the residual value grade, when the credit grade of the owner is lower than a reference value, the owner's relative residual value is determined to be one grade down, and when the credit grade of the owner is higher than the reference value, the owner's relative residual value grade is determined to be one grade up. Since the residual value may be varied in the future depending on the credit grade of the owner, the owner's credit grade is considered along with the residual value grade.

The real property transaction screen generator 330 may display the real property information, transaction information, fake listing verification information, and relative residual value grade per target property.

The real property transaction screen provider 340 limits target properties for which to provide the real property information, transaction information, fake listing verification information, and residual value grades to real properties with the debt grade requested by the customer terminal 400. For example, upon receiving a request for information about real properties with the ‘good’ debit grade from the customer terminal 400, the real property transaction screen provider 340 provides the real property information, transaction information, fake listing verification information, and residual values only for target properties with the good debt grade. This allows customers an easier search per debt grade.

Likewise, the real property transaction screen provider 340 limits target properties for which to provide the real property information, transaction information, fake listing verification information, and debt grades to real properties with the residual value grade requested by the customer terminal 400. For example, upon receiving a request for information about real properties with the ‘good’ residual value grade from the customer terminal 400, the real property transaction screen provider 340 provides the real property information, transaction information, fake listing verification information, and debt grades only for target properties with the good residual value grade. This allows customers an easier search per residual value grade.

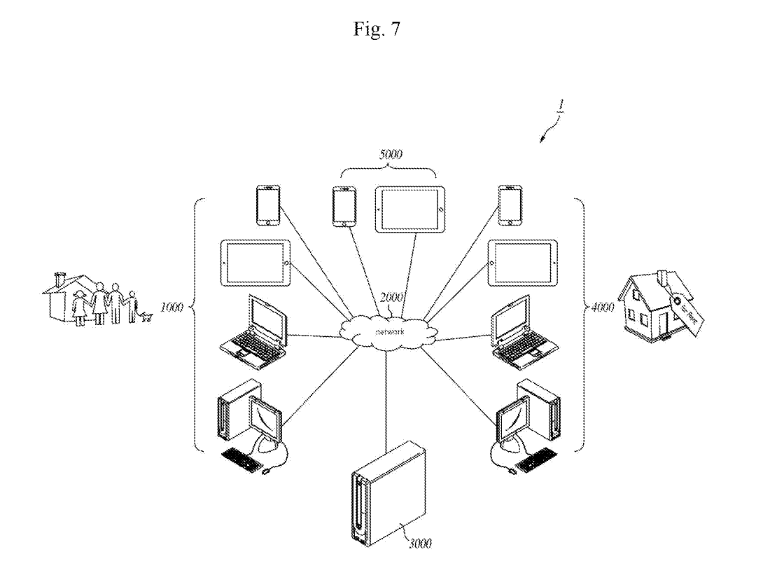

FIG. 7 is a view illustrating a safe transaction service providing system for a real property using bigdata-based grade classification and market value prediction according to an embodiment. Referring to FIG. 7, a real property safe transaction service providing system 1 using bigdata-based grade classification and market value prediction may include a tenant terminal 1000, a safe transaction service providing server 3000, a landlord terminal 4000, and an agent terminal 5000. However, the real property safe transaction service providing system 1 of FIG. 7 is merely an example, and the scope of the present invention is not limited by FIG. 7.

The components of the real property safe transaction service providing system 1 are connected together via a network 2000. For example, referring to FIG. 7, the tenant terminal 1000 may be connected with the safe transaction service providing server 3000 via the network 2000. The safe transaction service providing server 3000 may be connected with the tenant terminal 1000, the landlord terminal 4000, and the agent terminal 5000 via the network 2000. The landlord terminal 4000 may be connected with the safe transaction service providing server 3000 via the network 2000. The agent terminal 5000 may be connected with the tenant terminal 1000, the safe transaction service providing server 3000, and the landlord terminal 4000 via the network 2000.

Here, the term “network” means a connecting structure to enable exchanging of information between nodes, such as a plurality of terminals and servers. Examples of such network may include, but are not limited to, a radio frequency (RF) network, a 3rd Generation Partnership Project (3GPP) network, a Long Term Evolution (LTE) network, a Long Term Evolution-Advanced (LTE-A) network, a 5th Generation Partnership Project (5GPP) network, a World Interoperability for Microwave Access (WIMAX) network, an Internet network, a Local Area Network (LAN) network, a Wireless LAN network, a Wide Area Network (WAN) network, a Personal Area Network (PAN) network, a Bluetooth network, a satellite broadcast network, an analog broadcast network, and a Digital Multimedia Broadcasting (DMB) network.

As used herein, the singular forms “a,” “an,” and “the” are intended to include the plural forms as well, unless the context clearly indicates otherwise. According to embodiments, a plurality of components of the same type may be a single component of the type, and one component may add one or more components of the same type.

The tenant terminal 1000 may be a terminal to search for real properties using a webpage, app page, program, or application related to the real property safe transaction service using bigdata-based grade classification and market value prediction. The tenant terminal 1000 may be a terminal that a tenant uses. The tenant terminal 1000 may allow the tenant to enter his desired conditions, receive results meeting the conditions from the safe transaction service providing server 3000, and outputs the results. The tenant terminal 1000 may filter fake listings or duplicate listings using a fake listing filtering function. Upon searching for multi-unit buildings, the tenant terminal 1000 may search for information about tenants similar to rent listings, except for unique identification information. To prevent leakage of others' information searched for, such an implementation may be made that the information about other (similar) tenants may be searched for under the condition where the tenant's information is listed up, but embodiments of the disclosure are not limited thereto. When the tenant enters a keyword onto the tenant terminal 1000, the safe transaction service providing server 3000 may recommend or automatically enter similar keywords to the entered keyword using an advanced search function and provide results completely matching the tenant's entered keyword or results matching the recommended similar keywords. For example, the tenant who is unfamiliar with real property business terms may enter inappropriate keywords, and wrong results may thus be displayed. In this case, the tenant may be unhappy with the results. The safe transaction service providing server 3000, despite entry of a wrong keyword by the tenant, may do a search with a correct keyword or its associated keywords, using the classification and clustering of the keyword database, thus presenting correct results.

The tenant terminal 1000 may be implemented as a computer capable of accessing a remote server or terminal via the network. Here, the computer may be, e.g., a navigation or web browser-equipped laptop computer or desktop computer. The tenant terminal 1000 may be implemented as a terminal capable of accessing a remote server or terminal via the network. The tenant terminal 1000 may be, e.g., a portable mobile wireless communication device examples of which may include navigation devices, a Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, a smartphone, a smartpad, tablet PC, or any other various types of handheld wireless communication devices.

The safe transaction service providing server 3000 may be a server to provide a webpage, app page, program, or application related to the real property safe transaction service using bigdata-based grade classification and market value prediction. Where there is one real property rented, the safe transaction service providing server 3000 may enable only one listing to be outputted. The safe transaction service providing server 3000 may verify whether listings are fake listings, whether real properties rented are under mortgage or foreclosure and provide such information to the tenant terminal 1000 while publishing the tenant's rent payment status or history, thereby allowing for selection of a desired tenant and a desired landlord. To allow the tenant to have her desired neighbors when the tenant searches for multi-unit buildings, the safe transaction service providing server 3000 may provide information about the people residing in the upper, lower, left, and right units of the rented real property, except for unique identification information about the people, in a form statistically processed. To prevent private information leakage, the safe transaction service providing server 3000 may also store information about the person who has looked up the information, so that when the information about the others leaks out, the searcher is traceable. The safe transaction service providing server 3000 may manage sellers and buyers, as well as tenants and landlords, in different classifications, define and store circumstances where they all may be damaged, monitor, trace, and intensively manage someone who causes such a circumstance, thereby preventing any damage in advance. The safe transaction service providing server 3000 may gather transaction statuses for real properties for sale or rent in the form of bigdata and may predict market values using indexes influencing the market value for rent or sale, e.g., such indexes as a rise or fall in interest rate. The safe transaction service providing server 3000 may provide detailed market values depending on conditions based on the aspect where an apartment is subject to price variations depending on its floor number or location, or whether they are of corridor access or not. To that end, the safe transaction service providing server 3000 may build up bigdata using the agent terminal 5000 and pre-stored history log data, and classify, cluster, and learn the bigdata via gathering, pre-processing, and analysis. To extract an identifier from image or video data which is unstructed, the safe transaction service providing server 3000 may learn data using a deep learning artificial neural network algorithm to tag the identifier from the image or video data. The safe transaction service providing server 3000 may tag or extract identifiers from images or videos entered later depending on the results of learning.

The safe transaction service providing server 3000 may be implemented as a computer capable of accessing a remote server or terminal via the network. Here, the computer may be, e.g., a navigation or web browser-equipped laptop computer or desktop computer.

The landlord terminal 4000 may be a terminal that is used by the landlord using a webpage, app page, program, or application related to the real property safe transaction service using bigdata-based grade classification and market value prediction. The landlord terminal 4000 may list up the landlord's real property and receive the results, in the form of graph or alert, of tracing the market value and transaction status of the ambient real properties from the safe transaction service providing server 3000. The landlord terminal 4000 may output data obtained by statistically processing the hit count of users who searched for the real property and information about the users and output the market value of the ambient real properties with the same condition. The landlord terminal 4000 may receive information about people who come to see the real property from the safe transaction service providing server 3000, allowing the landlord to choose his desired tenant. The landlord terminal 4000 needs to register its own information in the safe transaction service providing server 3000. For example, the landlord terminal 4000 may provide information about whether a mortgage is attached to the reception, whether the real property is under foreclosure, or the debt ratio, allowing the tenant to easily grasp whether she can get her deposit back.

The landlord terminal 4000 may be implemented as a computer capable of accessing a remote server or terminal via the network. Here, the computer may be, e.g., a navigation or web browser-equipped laptop computer or desktop computer. The landlord terminal 4000 may be implemented as a terminal capable of accessing a remote server or terminal via the network. The landlord terminal 4000 may be, e.g., a portable mobile wireless communication device examples of which may include navigation devices, a Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, a smartphone, a smartpad, tablet PC, or any other various types of handheld wireless communication devices.

The agent terminal 5000 may be a terminal that is used by the real property agent that does brokerage using a webpage, app page, program, or application related to the real property safe transaction service using bigdata-based grade classification and market value prediction. The agent terminal 5000 may enter or receive information about the landlord terminal 4000, status information and transaction information about the real property rented and may look up fake listings, or double sale or contracts.

The agent terminal 5000 may be implemented as a computer capable of accessing a remote server or terminal via the network. Here, the computer may be, e.g., a navigation or web browser-equipped laptop computer or desktop computer. The agent terminal 5000 may be implemented as a terminal capable of accessing a remote server or terminal via the network. The agent terminal 5000 may be, e.g., a portable mobile wireless communication device examples of which may include navigation devices, a Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, a smartphone, a smartpad, tablet PC, or any other various types of handheld wireless communication devices.

A seller terminal (not shown) and a buyer terminal (not shown) may perform the same or similar operations to the above-described landlord terminal 4000 and the tenant terminal 1000, respectively, and no description thereof is given. The seller terminal and the buyer terminal may be monitored as per classifications made by the safe transaction service providing server 3000. The seller terminal and the buyer terminal may be required to first list up their own information before being able to see information about the opposite party.

The seller terminal and the buyer terminal may be implemented as computers capable of accessing a remote server or terminal via the network. Here, the computer may be, e.g., a navigation or web browser-equipped laptop computer or desktop computer. A manager terminal (not shown) may be implemented as a terminal capable of accessing a remote server or terminal via the network. The manager terminal (not shown) may be, e.g., a portable mobile wireless communication device examples of which may include navigation devices, a Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, a smartphone, a smart pad, tablet PC, or any other various types of handheld wireless communication devices.

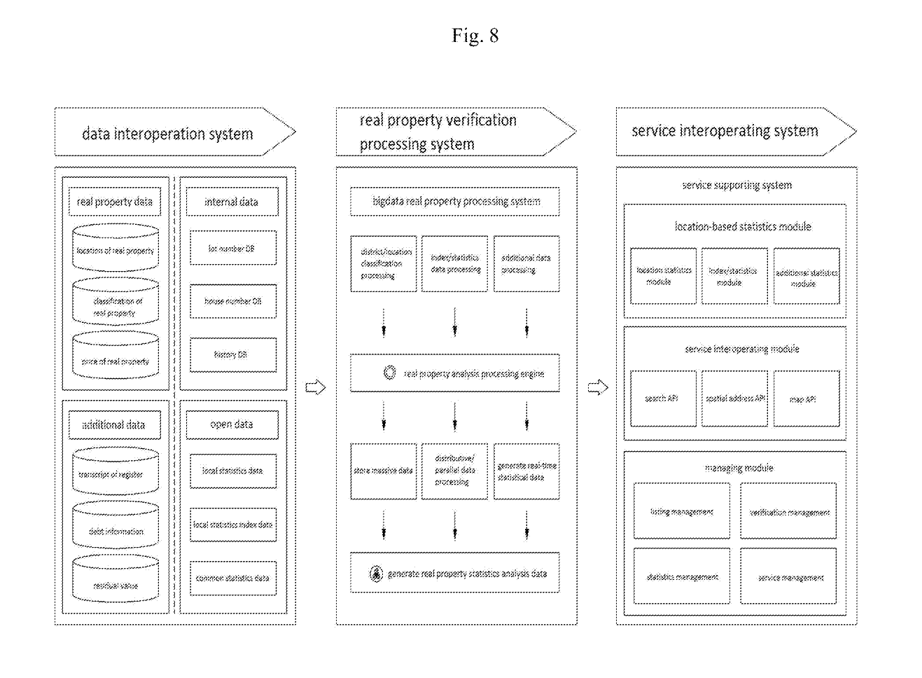

FIG. 8 is a block diagram illustrating a configuration of a system for providing a real property service based on bigdata by a safe transaction service providing server included in the system of FIG. 7.

According to an embodiment, where the safe transaction service providing server 3000 or a server (not shown) interoperating with the safe transaction service providing server 3000 transmits a real property safe transaction service application, program, app page, or webpage using bigdata-based grade classification and market value prediction to the tenant terminal 1000, the landlord terminal 4000, and the agent terminal 5000, the tenant terminal 1000, the landlord terminal 4000, and the agent terminal 5000 may install and open the real property safe transaction service application, program, app page, or webpage. A service program may be driven on the tenant terminal 1000, the landlord terminal 4000, and the agent terminal 5000 using a script executed on a web browser. Here, the web browser may be a program or application that enables use of world wide web (WWW) services or that receives and shows hyper text written in the hyper text mark-up language (HTML), and the web browser may include, e.g., Netscape, Explorer, or Chrome. The term “application” may mean an application executed on the terminal, and the application may include, an app running on a mobile terminal, e.g., a smartphone.

Referring to FIG. 8, the safe transaction service providing server 3000 may output fake listing data regarding a real property for rent registered from the landlord terminal 4000 upon listing up the real property, transmit data about the tenant terminal 1000, except for the unique identification information, and rent payment status data to the landlord terminal 4000 when the tenant terminal 1000 looks up the real property for rent, assign user management grades to the tenant and the landlord based on the tenant information and the landlord information, determine whether the tenant and the landlord need to be monitored or managed, and serve bigdata-based real property statistical analysis data.

The safe transaction service providing server 3000 may gather, in the form of bigdata, real property data including the location, classification, and price of the real property, internal data including the lot number and house number, additional data including the register transcript, debt information, and residual value information, and open data including local statistics and index data. The debt information includes information about whether the real property registered is under mortgage or foreclosure and the maximum claim amount shown on the register transcript, and the residual value may be generated with the landlord's credit grade reflected as a weight.

To build up bigdata, the safe transaction service providing server 3000 may refine unstructed data, strutted data, and semi-structed data contained in the raw data stored, perform pre-processing including classification with metadata, and perform analysis, including data mining, on the pre-processed data. The safe transaction service providing server 3000 may visualize and output the analyzed data. Data mining may perform classification to discover internal relations between the processed data pieces and predict a new data class by learning a training data set whose class is known or clustering to group data based on similarity without class information. There may be provided other various types of data mining. Data mining may be performed differently depending on the type of bigdata or the type of query to be made later. The bigdata built up may undergo a verification process by artificial neural network deep learning or mechanical learning.

The artificial neural network may adopt the convolutional neural network (CNN) structure because the CNN has a network structure using the convolution layer, is appropriate for image processing, and may use image data as inputs and classify images based on the features of the images.

Text mining is technology for extracting and processing useful information from unstructed/semi-strutted text data based on natural language processing technology. Text mining may be used to extract meaningful information from massive data clumps, grasp associations with other information, discover the category of the text, and obtain results more than those by a mere information search. Using data mining or text mining, the safe transaction service according to the present invention may use a statistical, regular algorithm and massive language resources to analyze the identifier or natural language entered as a query and to dig out information hidden therein.

The landlord terminal 4000 may register information about the real property for rent, search for information, e.g., market value, about ambient real properties with the same or similar conditions to the registered real property, when the registered real property is looked up, output statistically processed data for the registered real property including the hit count for the registered real property and information about the people who saw the real property, except for their unique identification information, and output information about a person that reserved for the registered real property so that the transaction status for the real property can be checked in real-time. The tenant terminal 1000 may search for the real property by entering at least one condition, unless the real property is searched for in real-time, apply for a notification that is to be sent when a real property meeting the condition is registered or listed up, and output the result of verifying whether the registered real property is a fake.

The safe transaction service providing server 3000 may, in a parallel and distributive manner, store the gathered raw data, which is bigdata, refine unstructed data, strutted data, and semi-structed data contained in the raw data stored, perform pre-processing including classification with metadata, perform analysis, including data mining, on the pre-processed data, and visualize and output the analyzed data.

The safe transaction service providing server 3000 may provide a semantic search-based search engine that allows a machine to understand real property search conditions that humans use, thus allowing buyers or tenants convenient use. For example, the safe transaction service providing server 3000 may build up a listing ontology to enable a search for sale or rent listings using semantic web technology and use the results of surveys targeting real property agents and customers to verify the validity of the search conditions. The safe transaction service providing server 3000 may be configured to analyze the results of surveys in an analytic hierarchy process (AHP), design a semantic real property knowledge information system architecture, and provide the optimal real property candidate via the user's query search and using the built-up ontology. To that end, the results of search obtained may be analyzed by multi-attribute decision making (MADM), but embodiments of the disclosure are not limited thereto.

An apartment house is taken as an example. Search conditions for the apartment may be factors for evaluating the real property. The real property evaluation factors may matter to forming the price of the real property. Existing real property price forming factors may be used to define the factors for assessing the value of the real property in a clearer and more detailed manner. The price of a real property is formed as follows. First, a price range is formed by community factors, and a specific price is then formed by individual factors. The community factors comply with standardized use according to the demand and supply in the local market and form the price range. In contrast, the individual factors may present individual, specific prices by reflecting the individual characteristics for the real property. The community factors may include, e.g., school district, public transportation, cultural facilities, purchase of goods for daily use, and commuting distance, and the individual factors may include, e.g., the size, floor number, direction, room count, view, household count, grade of the construction company, year of founding, and amenities. The safe transaction service providing server 3000 may gather keywords that are entered by the users searching for the real property and analyze, or update with, the factors.

People oftentimes use such keywords as “good view,” “close to subway,” and “very clean,” unless they frequently do a search, and these words are natural language and subjective recognition terms. In terms of such use of the terms, all concepts used to search for an apartment need to be converted in a standardized language, and there is a need for ontology to represent them in a consistent manner. In other words, such ontology is implemented as to systemize relevant terms and infer the relationship between the terms so that a machine can understand subjective recognition terms that humans do. Thus, the safe transaction service providing server 3000 may be configured to address the problem of presenting only results corresponding to entered keywords and to output results complying with the user's intent even when he enters a wrong keyword.

The safe transaction service providing server 3000 may separately store market values depending on lot numbers and house numbers in the form of history logs and may use at least one economical index that may influence the market value to provide a market value prediction according to the lot number and house number. An example of the at least one economical index may be, but is not limited to, the base interest rate published by the Bank of Korea.

A number of factors may work to raise the price of real property, some representative examples of which have been chosen by researches as common factors influencing the variation in real property price. The price of real property is determined by the demand-and-supply law. Thus, if demand for real property increases, the price increases as well. In other words, research on factors to increase real property demand may be a good way to figure out factors to lead to a price rise. According to an embodiment, the following may be factors that vary real property price, but embodiments of the disclosure are not limited thereto.

Real property price forming factors may include common factors, community factors, and individual factors. The common factors mean factors that may influence the price of all real properties in the whole society and economy, not only in a specific district or for a particular real property. The common factors may be divided into social, economical, and administrative factors. The social factors may include population, population growth, population structure, per-household population, and lifestyle, and the economical factors may include saving, consumption, investment, income, product price, employment, and industrial structure. The administrative factors may include construction regulations and restrictions, land use plans, and real property policies. The community factors refer to natural, social, economical and administrative factors that influence the price range for the community, local area, or district, and the community factors may be a shrunken version of the above-mentioned common factors in terms of community. Representative examples of the community factors may include population characteristics in terms of community, local economy trends, administrative regulations per community, and natural environments. The individual factors are ones that directly affect the price of individual real properties and individual factors may play a direct and significant role to the transaction of individual real properties. The economical factors are representative environmental factors affecting the real property market and require a detailed approach in terms of macroeconomics and microeconomics. Representative examples of the economical factors include economy growth, economy fluctuations, product price, inflation, money supply, stock price, interest rate, income, and consumption. The social and cultural factors include population, household, custom, tradition, and traditional values, and such factors may steadily influence the real property price in the community. Legal, system, and policy factors are a representative example of showing how the government understands the current real property market. These factors have a very close relationship with legislation and law amendment and are thus powerful enough to change the real property price in a wide area at once.

Although the market value may be predicted with a prediction algorithm considering all the enumerated factors, such a prediction method is also possible where a future price variation is predicted from value variations and based on the market price of the ambient real properties and the price rising trend. It will readily be appreciated by one of ordinary skill in the art that other various factors than the above-enumerated factors may also influence the real property price.

Regarding the user management grade, the safe transaction service providing server 3000 may designate a management grade to a landlord who, despite the presence of a valid rent contact with a tenant, proceeds with another rent contract with a third party or for whom a brokerage accident history is discovered or may designate a monitoring grade to a tenant who delays rent payment a preset number or more and for whom a preset condition is met and thus a complaint is made from the landlord. The safe transaction service providing server 3000 may designate a special management grade to a seller with a seller terminal who withdraws his real property from the list at a preset frequency or cycles after negotiating a sale contract with a buyer or for whom a brokerage accident occurs, and the safe transaction service providing server 3000 may designate a special management grade to a buyer who requests to lower the price after negotiating a sale contract with a seller or for whom a brokerage accident occurs.

The safe transaction service providing server 3000 may generate a recommendation list based on the tenant's preference and the similarity of the real property for rent which meets at least one condition with a list of real properties for rent output under at least one condition, transmits the recommendation list to the tenant terminal 1000, and where the real property in the real property list is an apartment house, transmit tenant information about any one of the upper, lower, left, and right apartment houses of the target apartment house, with the unique identification information excluded, to the tenant terminal 1000. For example, A works from 9 AM to 6 PM and sleeps from 9 PM to 7 AM. If a family with an infant resides in the upper apartment of the target apartment, the tenant, although satisfied with the price, would not enter into a rent contact to avoid any possible conflicts with the neighbor and to remain quiet. Considering such scenario case, the safe transaction service providing server 3000 may filter out real properties for rent with such factors, saving the tenant from unnecessary time consumption and minimizing problems that may arise after entering into a contact.

When the tenant enters at least one condition and searches for real properties for rent, the safe transaction service providing server 3000 may extract and search for a keyword corresponding to the at least one condition and a set of similar or associated words with the keyword from the database previously storing the keyword set, and where the real property is searched for with an associated and similar word which is not the same as the keyword, allows the similarity between the keyword corresponding to the at least one condition and the searched-for real property on the real property list which is output from the tenant terminal 1000. This has a similar start point to the above-described semantic web. For example, a person who is not familiar with search may not choose a proper keyword, and the search engine, by its nature, only presents results with the keyword. This ends up with such result as if he makes a wrong question, and thus receives a wrong answer. The safe transaction service providing server 3000 may build up a database in which wrong questions are associated with correct answers by gathering bigdata. For example, upon gathering histories for people who keep asking wrong inquiries in the form of logs, the safe transaction service providing server 3000 may stop the process when meeting a certain result or creating bigdata for the process of continuing to find a correct answer, thereby creating bigdata for a set of wrong inquiries and arranging keywords by which a correct answer can be obtained, or searching together and hence allowing for a search for the correct answer. For example, it is assumed that A is a correct inquiry, and B is an answer to A, and an unskilled user finds B while searching C-D-E-F-G. In this case, the safe transaction service providing server 3000 may match C, D, E, F, and G with A, and if C, D, E, F, or G is entered, allows A to be entered and searched together, thereby giving the correct answer despite entry of a wrong inquiry.

The real property safe transaction service providing system 1 may further include the agent terminal 5000 that provides real property for rent registered by the landlord to the safe transaction service providing server 3000. Where real properties with the same address as the registered real property are listed up in duplicate by different agent terminals 5000, the safe transaction service providing server 3000 may abstain from listing the real property up on the webpage, which the safe transaction service providing server 3000 provides, or deactivate the real property.

What is not described regarding the real property safe transaction service providing method using bigdata-based grade classification and market value prediction in connection with FIG. 8 is the same or easily inferred from what has been described regarding the real property safe transaction service providing method using bigdata-based grade classification and market prediction in connection with FIG. 7, and no detailed description thereof is thus presented.

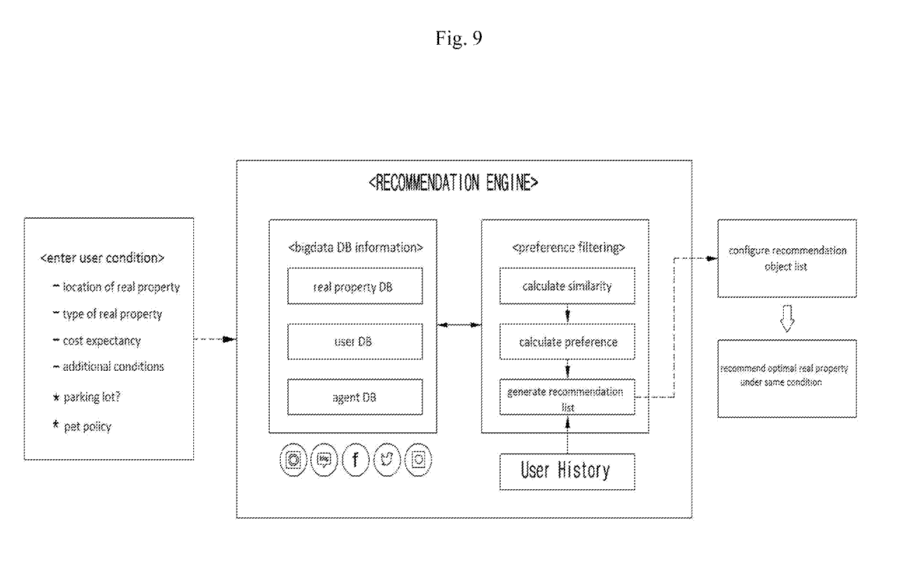

FIG. 9 is a view illustrating an exemplary implementation of a service of recommending a real property for sale while reflecting input conditions by a safe transaction service providing server included in the system of FIG. 7. Referring to FIG. 9, where a user (e.g., a buyer or tenant) enters, e.g., the location or type of a real property, expected price, or additional conditions, the safe transaction service providing server 3000 may generate a recommendation list based on similarity and preferences and may recommend the optimal real property among the real properties with the same condition.

The reason why information is very critical to real property transactions is that real property has its unique location and physical characteristics unlike other properties. By the nature of real property, there are no real properties with the same condition and nature, and real property has such characteristics as being immovable, fixed, and individual. However, real property information that the parties of the real property transaction desires to know is mostly provided from a governmental organization and is distributed and managed by several departments of the governmental organization which has first produced the real property information. According to an embodiment, the transaction information association services from the public sector and private sector may be provided. Since the real property information provided from the public sector and the real property information provided from the private sector differ from each other in terms of information to be built up, services are also operated differently depending on purposes, uses, or use entities. However, since users desire to intuitively compare and obtain various pieces of information on a single screen, it may be possible to quickly provide accurate real property information by providing association services between the public sector and the private sector. For example, it is possible to build up a model capable of providing, e.g., land information (e.g., land registration administration, such as Korea. Land Information System (KLIS)) and building information (e.g., internet architectural administration information system (e-AIS)) and price information on a single screen which is geographical information system (GIS)-based per-lot comprehensive information.

It is also possible to propose the optimal one among search results meeting the preference and similarity by using together a substitution real property price verification service, time-series price analysis, and price variation analysis via basic statistical value and house price index calculation analysis based on space information, attribute information, public information, and private information.

What is not described regarding the real property safe transaction service providing method using bigdata-based grade classification and market value prediction in connection with FIG. 9 is the same or easily inferred from what has been described regarding the real property safe transaction service providing method using bigdata-based grade classification and market prediction in connection with FIGS. 7 and 8, and no detailed description thereof is thus presented.

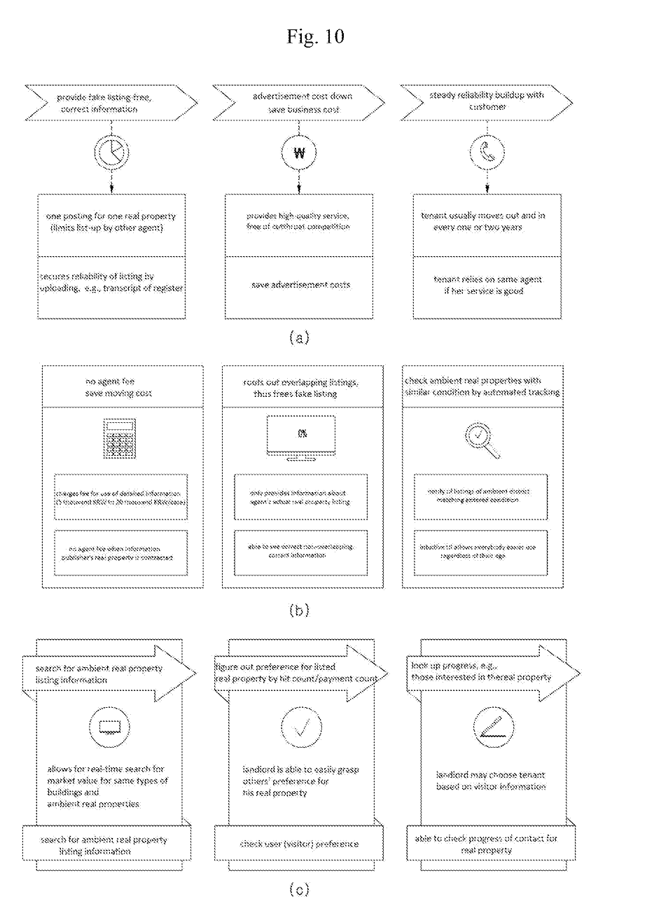

FIG. 10 is a view illustrating functions that a safe transaction service providing method for a real property using bigdata-based grade classification and market value prediction provides to an real property agent, a tenant, and a landlord, according to an embodiment. Referring to FIG. 10(a), according to an embodiment, where one post is already listed up for one real property, the argent cannot upload a listing with the same address, and reversely, if the agent herself has uploaded the listing, others cannot upload listings with the same address. By the nature of house rent, tenants tend to move within a short distance every six months or two years. Thus, whether the agent is entrusted to handle the customers' rent contacts depends on her service quality or reliability. Therefore, the platform of the present invention may root out fake listing and double transaction problems and provide a means capable of establishing steady reliability with the customers.

The fake listing issue may easily be addressed by preventing the same real property from being listed up in duplicates. For example, sale of real properties is mostly price-fixed, not departing off a certain tolerance range. However, rent may proceed in various different types and may be price-varied. For example, a rent contact may come with various options, e.g., a deposit of 50 million KRW with no monthly payment, each monthly payment of 100,000 KRW with a deposit of 40 million KRW, each monthly payment of 200,000 KRW with a deposit of 30 million KRW, or each monthly payment of 400,000 KRW with a deposit of 10 million KRW. Thus, the fake listing issue can simply be addressed by a method for preventing double listings with the same address rather than finding out the listings with the same option. The user may identify various options on the basis of the address and be avoided from double listings and resultantly fake listings. It is apparent to one of ordinary skill in the art not to exclude any method for finding the same real property based on the options.

Referring to FIG. 10(b), the user, e.g., buyer or tenant, may save agent fees. Further, since the fake listing problem is removed, and only information about actual real properties for sale or rent is listed up, reliable transactions may be made. Further, automated tracking enables discovery and tracking of real properties with similar conditions to those the user seeks, thereby allowing for an intuitive and easier search for a real property even without a difficulty in choosing a keyword.

Referring to FIG. 10(c), the landlord or seller may search for information about ambient real properties for sale or rent similar to its own real property, identify the market value or information about the similar real properties around in real-time, and gather information about how many people looked at his real property in how much interest and are thus allowed to enter into a contact with a buyer or tenant that meets the conditions the seller or landlord offers.

What is not described regarding the real property safe transaction service providing method using bigdata-based grade classification and market value prediction in connection with FIG. 10 is the same or easily inferred from what has been described regarding the real property safe transaction service providing method using bigdata-based grade classification and market prediction in connection with FIGS. 7 to 9, and no detailed description thereof is thus presented.

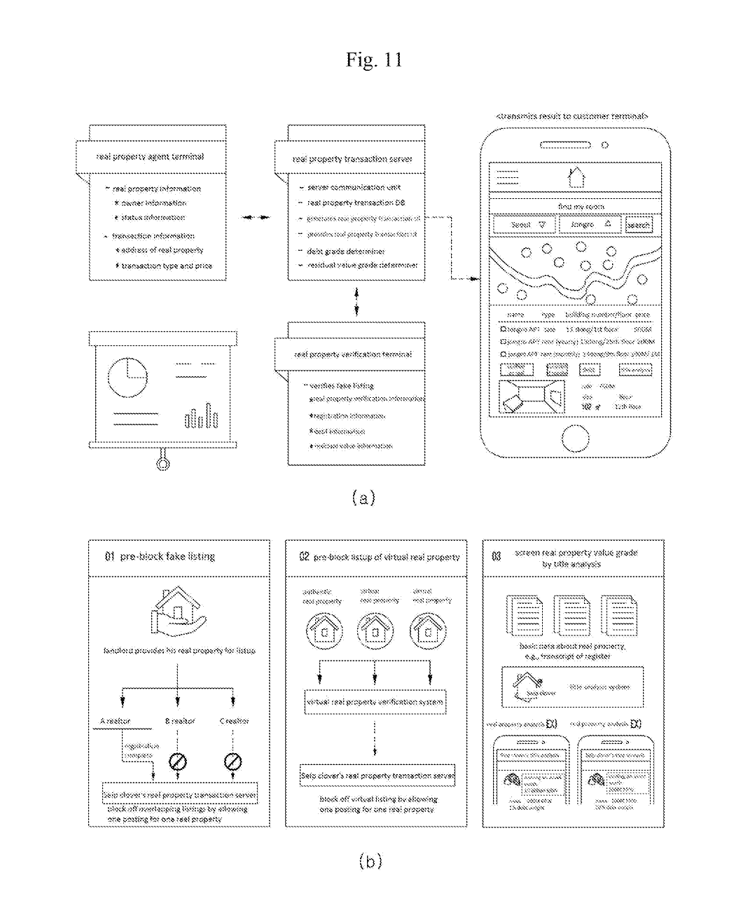

FIG. 11 is a view illustrating an example of verifying a fake listing by a safe transaction service providing method for a real property using bigdata-based grade classification and market value prediction according to an embodiment. Referring to FIG. 11, according to an embodiment, to prevent fake listings or double sales, fake listings or double sales may be monitored via various pieces of information. Where an authentic real property listing is uploaded, other requests for listing up for the same real property may be disregarded or discarded or deactivated. Title analysis on whether the real property is safe enough to enter into a contact with may be provided at low cost. Thus, cutthroat competition among agents or realtors and a deterioration of the user's reliability may be prevented.

What is not described regarding the real property safe transaction service providing method using bigdata-based grade classification and market value prediction in connection with FIG. 11 is the same or easily inferred from what has been described regarding the real property safe transaction service providing method using bigdata-based grade classification and market prediction in connection with FIGS. 7 to 10, and no detailed description thereof is thus presented.

The real property safe transaction service or method using bigdata-based grade classification and market value prediction according to an embodiment described with reference to FIG. 11 may be implemented in the form of a recording medium or computer-readable medium containing computer-executable instructions or commands, such as an application or program module executable on a computer. The computer-readable medium may be an available medium that is accessible by a computer. The computer-readable storage medium may include a volatile medium, a non-volatile medium, a separable medium, and/or an inseparable medium. The computer-readable medium may include a computer storage medium. The computer storage medium may include a volatile medium, a non-volatile medium, a separable medium, and/or an inseparable medium that is implemented in any method or scheme to store computer-readable commands, data architecture, program modules, or other data or information.

According to an embodiment, the above-described real property safe transaction service or method using bigdata-based grade classification and market value prediction may be executed by an application installed on a terminal, including a platform equipped in the terminal or a program included in the operating system of the terminal), or may be executed by an application (or program) installed by the user on a master terminal via an application providing server, such as a web server, associated with the service or method, an application, or an application store server. According to an embodiment, the above-described real property safe transaction service providing method using bigdata-based grade classification and market value prediction may be implemented in an application or program installed as default on the terminal or installed directly by the user and may be recorded in a recording medium or storage medium readable by a terminal or computer.

Although embodiments of the present invention have been described with reference to the accompanying drawings, It will be appreciated by one of ordinary skill in the art that the present disclosure may be implemented in other various specific forms without changing the essence or technical spirit of the present disclosure. Thus, it should be noted that the above-described embodiments are provided as examples and should not be interpreted as limiting. Each of the components may be separated into two or more units or modules to perform its function(s) or operation(s), and two or more of the components may be integrated into a single unit or module to perform their functions or operations.

According to embodiments of the disclosure, the system may provide correct real property information and prevent fake listings on websites or apps for real property transactions.

According to an embodiment, the system may prevent multiple listings for the same real property for, e.g., sale or rent from being made on websites or apps for real property transactions. In other words, a single listing may be permitted for the same real property for transaction, thereby preventing the fake listing issue.

According to an embodiment, users of the service as per an embodiment of the disclosure may be classified under predetermined conditions and may be monitored or managed in real-time, thereby preventing any wrongful or malicious acts that may disturb the real property market.

According to an embodiment, the system as per an embodiment of the disclosure may provide market value prediction, allowing potential purchasers or tenants to quickly make up their mind as to whether to buy or rent real property they are interested in. Such user grade classification and market value prediction may be provided based on bigdata.

According to embodiments of the disclosure, an expert analysis and opinion on a real property to be transacted may be provided. Thus, the exact address of the target real property may be provided regardless of whether the real property is subject to sale, rent, or whatever transaction, thereby preventing fake listings. Further, correct information about the target real property, such as whether the real property is mortgaged, foreclosed, or auctioned, and the owner's debit information, may be analyzed and provided, and a safer transaction is rendered possible for the target property.

While the disclosure has been shown and described with reference to exemplary embodiments thereof, it will be apparent to those of ordinary skill in the art that various changes in form and detail may be made thereto without departing from the spirit and scope of the disclosure as defined by the following claims.

What is claimed is:

1. A system for providing real property information, the system comprising:
an agent terminal configured to receive real property information including information about an owner and a status of a target property and transaction information including an address, a transaction type, and a transaction price for the target property and to transmit the real property information and the transaction information to an transaction server to register the real property information and the transaction information in the transaction server;
a real property verification terminal configured to receive the real property information and the transaction information from the transaction server, receive fake listing verification information about the target property, and transmit the fake listing verification information to the transaction server;
the transaction server configured to receive the real property information and the transaction information about the target property from the agent terminal, transmit the real property information and the transaction information to the real property verification terminal, receive the fake listing verification information from the real property verification terminal, generate a real property transaction screen displaying real property information, transaction information, and fake listing verification information per target property, and provide the real property transaction screen to a customer terminal; and
a wired/wireless communication network configured to provide wired communication or wireless communication among the agent terminal, the real property verification terminal, the customer terminal, and the transaction server.

2. The system of claim 1, wherein the fake listing verification information includes at least one or more of real property verification information verified as to whether the address of the target property is a property address provided from the agent terminal, registration information about the address of the target property, debt information setting forth on the register transcript for the target property and including information about whether the target property is mortgaged or is auctioned, and residual value information about the target property.

3. The system of claim 2, wherein the transaction server includes a server communication unit configured to communicate with each of the agent terminal and the real property verification terminal to receive the real property information and the transaction information about the target property from the agent terminal and receive the fake listing verification information from the real property verification terminal, a database configured to store and register, per target property, the real property information, the transaction information, and the fake listing verification information about the target property, a real property transaction screen generator configured to generate the real property transaction screen per target property, and a real property transaction screen provider configured to transmit the real property transaction screen to the customer terminal.

4. The system of claim 3, wherein the real property transaction screen generator is configured to, when two or more target properties with the same address are registered by different agent terminals, prevent the target properties from being shown on the real property transaction screen.

5. The system of claim 3, wherein the transaction server includes a debt grade determiner configured to determine a debt grade obtained by applying a degree of assets of the owner of the target property to the debt information, and wherein the real property transaction screen generator is configured to display, per target property, the debt grade, along with the real property information, the transaction information, and the fake listing verification information.

6. The system of claim 5, wherein the debt grade determiner is configured to generate a relative debt grade obtained by applying a credit grade, as a weight, of the owner of the target property to the debt grade, and wherein the real property transaction screen generator is configured to display, per target property, the relative debt grade, along with the real property information, the transaction information, and the fake listing verification information.

7. The system of claim 5, wherein the transaction server includes a residual value grade determiner configured to determine a residual value grade obtained by applying a degree of assets of the owner of the target property to the residual value information, and wherein the real property transaction screen generator is configured to display, per target property, the residual value grade, along with the real property information, the transaction information, and the fake listing verification information.

8. The system of claim 7, wherein the residual value grade determiner is configured to generate a relative residual value grade obtained by applying a credit grade, as a weight, of the owner of the target property to the residual value grade, and wherein the real property transaction screen generator is configured to display, per target property, the relative residual value grade, along with the real property information, the transaction information, and the fake listing verification information.

9. The system of claim 7, wherein the real property transaction screen provider is configured to limit target properties for which to provide the real property information, the transaction information, the fake listing verification information, and the residual value grades to real properties with the debt grade requested by the customer terminal and to limit target properties for which to provide the real property information, the transaction information, the fake listing verification information, and the residual value grades to real properties with the residual value grade requested by the customer terminal.

10. A system for providing a safe transaction service using bigdata-based grade classification and market value prediction, the system comprising:
a landlord terminal configured to register information about a real property for rent, search for information, including a market value, about ambient real properties with the same or similar conditions to the registered real property, when the registered real property is looked up, output statistically processed data for the registered real property including a hit count for the registered real property and information about people who looked up the real property, except for unique identification information about the people, and output information about a person that reserved for the registered real property so that a transaction status for the real property can be checked in real-time;
a tenant terminal configured to search for the real property by entering at least one condition, unless the real property is searched for in real-time, apply for a notification that is to be sent when a real property meeting the condition is registered or listed up, and output a result of verifying whether the registered real property is a fake; and
a safe transaction service providing server configured to output fake listing data regarding the real property for rent registered from the landlord terminal upon uploading the real property, transmit data about the tenant terminal, except for unique identification information about the tenant terminal, and rent payment status data to the landlord terminal when the tenant terminal looks up the real property for rent, assign user management grades to a tenant and a landlord based on information about the tenant and information about the landlord, determine whether the tenant and the landlord need to be monitored or managed, and serve bigdata-based real property statistical analysis data.

11. The system of claim 10, wherein the safe transaction service providing server is configured to gather, in a form of bigdata, real property data including a location, a classification, and a price of the real property, internal data including a lot number and a house number, additional data including a register transcript, debt information, and residual value information, and open data including local statistics and index data, and wherein the debt information includes information about whether the real property registered is under mortgage or foreclosure, and a maximum claim amount shown on the register transcript, and wherein the residual value is generated with the landlord's credit grade reflected as a weight.

12. The system of claim 10, wherein the safe transaction service providing server is configured to, in a parallel and distributive manner, store gathered raw data, which is bigdata, refine unstructed data, structed data, and semi-structed data contained in the raw data stored, perform pre-processing including classification with metadata, perform analysis, including data mining, on the pre-processed data, and visualize and output the analyzed data.

13. The system of claim 10, wherein the safe transaction service providing server is configured to separately store market values depending on lot numbers and house numbers in the form of history logs and use at least one economical index that may influence the market values to provide a market value prediction according to the lot number and house number.

14. The system of claim 10, wherein regarding the user management grade, the safe transaction service providing server is configured to designate a management grade to a landlord who, despite the presence of a valid rent contact with a tenant, proceeds with another rent contract with a third party or for whom a brokerage accident history is discovered or designate a monitoring grade to a tenant who delays rent payment a preset number or more and for whom a preset condition is met and thus a complaint is made from the landlord.

15. The system of claim 10, further comprising a seller terminal and a buyer terminal, wherein the safe transaction service providing server is configured to designate a special management grade to a seller with a seller terminal who withdraws his real property from the list at a preset frequency or cycles after negotiating a sale contract with a buyer or for whom a brokerage accident occurs and designate a special management grade to a buyer who requests to lower the price after negotiating a sale contract with a seller or for whom a brokerage accident occurs.

16. The system of claim 10, further comprising an agent terminal configured to provide the registered real property from the landlord to the safe transaction service providing server, wherein when real properties with the same address as the registered real property are listed up by different agent terminals, the safe transaction service providing server is configured to abstain from listing the real property up on a webpage, which the safe transaction service providing server provides, or deactivate the real property.

17. The system of claim 10, wherein the safe transaction service providing server is configured to generate a recommendation list based on the tenant's preference and the similarity of the real property for rent which meets at least one condition with a list of real properties for rent output under at least one condition and transmit the recommendation list to the tenant terminal and, when the real property in the real property list is included in a multi-unit building, transmit tenant information about any one of the upper, lower, left, and right apartment houses of the target apartment house, with the unique identification information excluded, to the tenant terminal.

18. The system of claim 10, wherein the safe transaction service providing server is configured to, when the tenant enters at least one condition and searches for real properties for rent, extract and search for a keyword corresponding to the at least one condition and a set of similar or associated words with the keyword from the database previously storing the keyword set, and when the real property is searched for with an associated and similar word which is not the same as the keyword, allow the similarity between the keyword corresponding to the at least one condition and the searched-for real property on the real property list which is output from the tenant terminal.
